(19) United States
(12) Patent Application Publication
(10) Pub. No.: US 2022/0400025 A1
(43) Pub. Date: Dec. 15, 2022

(54) AVAILABILITY POTENTIAL FOR INDIVIDUAL IN REMOTE MEETING

(71) Applicant: Lenovo (United States) Inc., Morrisville, NC (US)

(72) Inventors: Arnold Weksler, Raleigh, NC (US); John C. Mese, Cary, NC (US); Nathan Peterson, Oxford, NC (US); Russell Speight VanBlon, Raleigh, NC (US); Mark Delaney, Raleigh, NC (US)

(21) Appl. No.: 17/344,291

(22) Filed: Jun. 10, 2021

(51) Int. Cl. H04L 12/18; H04L 29/08

(52) U.S. Cl. CPC H04L 12/1831; H04L 12/1818; H04L 12/1822; H04L 67/24; H04L 67/22

(57) ABSTRACT

One embodiment provides a method, including: obtaining, at an information handling device and from one or more sources, context data associated with an individual participating in a remote meeting; determining, based on the context data, an involvement level of the individual in the remote meeting; identifying, based on the determining, an availability potential of the individual, wherein the availability potential is inversely proportional to the involvement level; and providing, based on the identifying, an indication of the availability potential to at least one other individual. Other aspects are described and claimed.

### BACKGROUND

Individuals frequently utilize information handling devices (“devices”), for example laptop and/or personal computers, tablet devices, hybrid devices, smart phones, and the like, to participate in remote meetings. More particularly, an individual may utilize their device to connect to an online remote meeting space (e.g., via a meeting application, etc.) in which they may interact and communicate with other meeting participants. Throughout the course of the meeting an individual's engagement level may fluctuate.

### BRIEF SUMMARY

In summary, one aspect provides a method, including: obtaining, at an information handling device and from one or more sources, context data associated with an individual participating in a remote meeting; determining, based on the context data, an involvement level of the individual in the remote meeting; identifying, based on the determining, an availability potential of the individual, wherein the availability potential is inversely proportional to the involvement level; and providing, based on the identifying, an indication of the availability potential to at least one other individual.

Another aspect provides an information handling device, including: a processor; a memory device that stores instructions executable by the processor to: obtain, from one or more sources, context data associated with an individual participating in a remote meeting; determine, based on the context data, an involvement level of the individual in the remote meeting; identify, based on the determining, an availability potential of the individual, wherein the availability potential is inversely proportional to the involvement level; and provide, based on the identifying, an indication of the availability potential to at least one other individual.

A further aspect provides a product, comprising: a storage device that stores code, the code being executable by a processor and comprising: code that obtains, from one or more sources, context data associated with an individual participating in a remote meeting; code that determines, based on the context data, an involvement level of the individual in the remote meeting; code that identifies, based on the code that determines, an availability potential of the individual, wherein the availability potential is inversely proportional to the involvement level; and code that provides, based on the code that identifies, an indication of the availability potential to at least one other individual.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing an indication of an availability potential of an individual participating in a remote meeting.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Individuals may be engaged in a variety of different activities throughout the course of a work day. In an effort to advertise their availability, an individual's status may be updated (e.g., manually by the individual, automatically by a system, etc.) and communicated to other individuals who may desire to contact them. For instance, a common status for an individual participating in a meeting (e.g., a remote meeting, etc.) may be something akin to “In-Meeting”, “Busy”, or some equivalent thereof. Such a status may inform other individuals that the meeting attendee likely will not see, or likely will not respond to, a received communication (e.g., an email, message, etc.) until at least the conclusion of the meeting.

In reality, a meeting attendee with an “In-Meeting” status may still be receptive to accepting and responding to various communications at certain points of the meeting. More particularly, an attendees' engagement with and/or involvement in a meeting may fluctuate over time. During periods of low meeting interest or involvement, the attendee may be able to see and/or respond to received communications without disrupting the flow of the meeting. For example, an individual may be an attendee in a meeting in which each team in a department provides an update on their project plans for the upcoming quarter. In such a situation, the individual may be very engaged in the meeting during their team's presentation but may not be as engaged when other teams are presenting their plans. Accordingly, the individual may be able to respond to communications received during these low engagement points without fear of jeopardizing their presentation responsibility or of causing a distraction to the other attendees.

No conventional methods exist that can dynamically inform other individuals that an attendee is amenable to receiving communications at certain points of a meeting. Existing solutions require the other individuals to attempt to contact the attendee (e.g., via a message or call, etc.) and see if they respond. However, such a method can be very disruptive to the attendee; especially if they are actively engaged in the meeting at the point the communication is received. Additionally or alternatively, the attendee may be able to utilize a “Do Not Disturb” status for the portions of the meeting in which they are actively participating. However, such a method requires an additional action that must be taken by the attendee and the attendee may forget to change this status when they are at a point in the meeting in which they are not very involved.

Accordingly, an embodiment provides a method for dynamically providing an availability potential for a participant engaged in a meeting. In an embodiment, context data associated with an attendee in a remote meeting may be obtained. For example, an embodiment may be able to identify: an attendee's role in the meeting (e.g., presenter, silent participant, etc.), the size of the meeting (e.g., large or small, etc.), a length of time since the attendee has provided input to the meeting, an attendee's responsiveness to other communications during the meeting, a combination thereof, and the like. From this context data, an embodiment may be able determine an involvement level of the individual in the meeting and can then identify, based upon this involvement level, an availability potential for the meeting attendee. The availability potential corresponds to a likelihood that the attendee is able to receive and respond to communications. Responsive to this identification, an embodiment may thereafter dynamically provide an indication of the availability potential to one or more other individuals (e.g., via an automatic status update, etc.). Such a method may therefore better inform other individuals about a point in a meeting that they may effectively communicate with a meeting participant.

The illustrated example embodiments will be best understood by reference to the figures. The following description is intended only by way of example, and simply illustrates certain example embodiments.

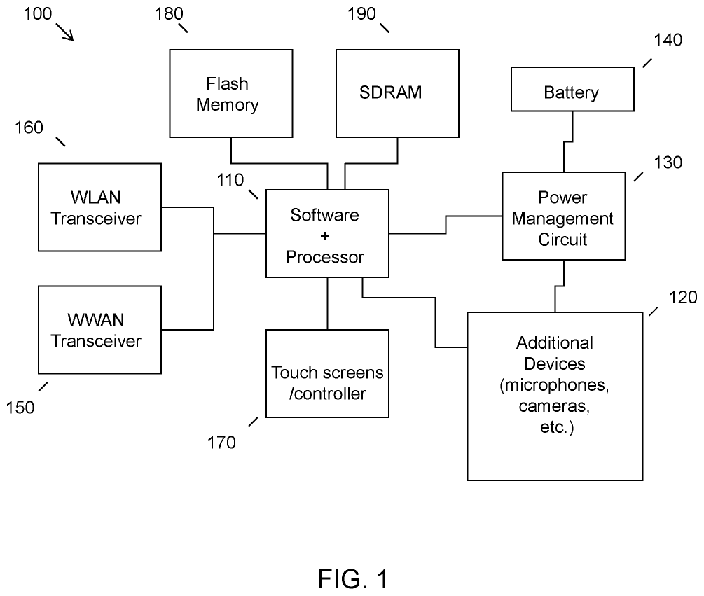

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

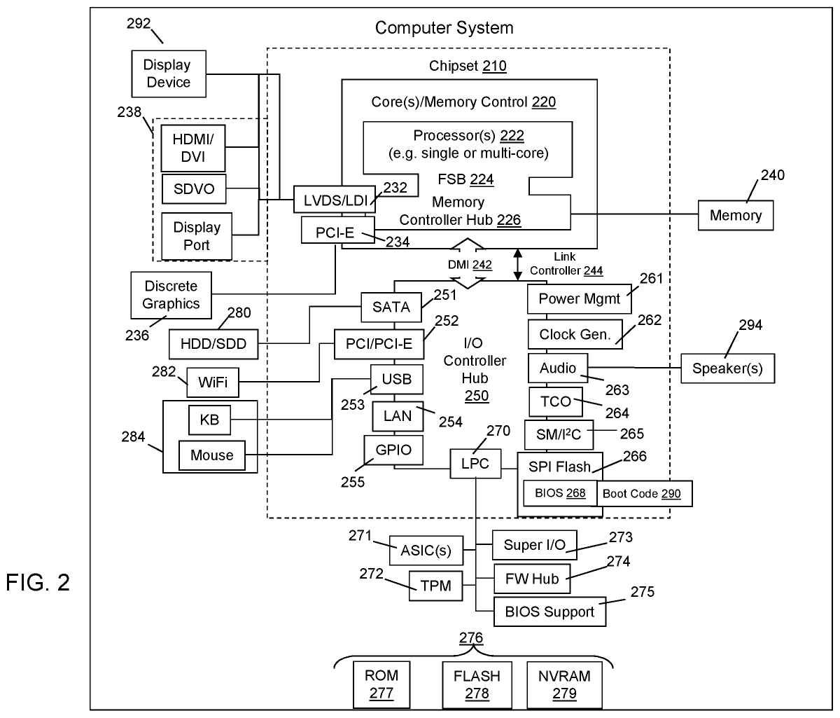

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices that can support a meeting application that enable users to connect to remote meetings or conferences. For example, the circuitry outlined in FIG. 1 may be implemented in a smart phone or tablet embodiment, whereas the circuitry outlined in FIG. 2 may be implemented in a laptop.

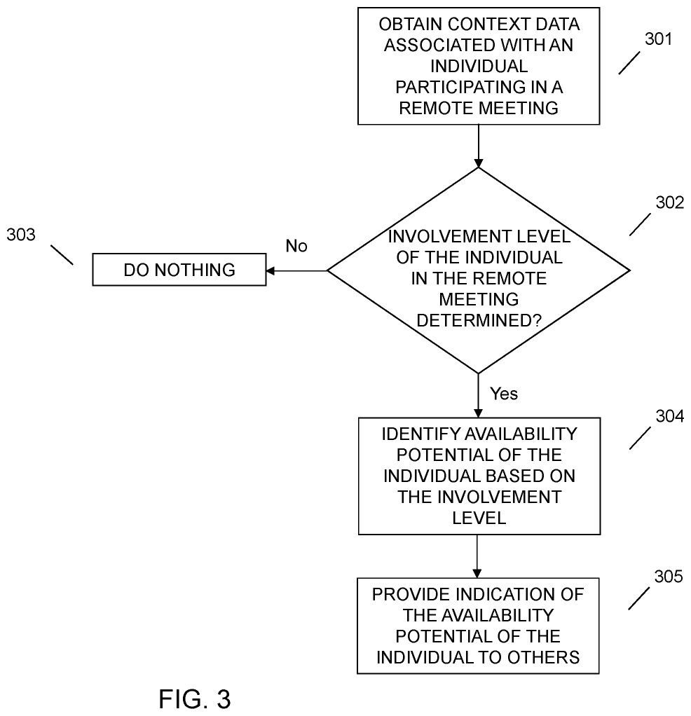

Referring now to FIG. 3, an embodiment provides a method of dynamically providing an indication of the availability potential of an attendee in a meeting to at least one other individual. At 301, an embodiment may obtain context data associated with an individual participating in a meeting. Responsive to obtaining this data, an embodiment may determine, at 302, an involvement level of the individual in the meeting. In the context of this application, the meeting may be a remote meeting or conference (i.e., that an individual attends via a meeting application resident on their device). Additionally, in the context of this application, the context data may refer to a current engagement and/or interaction level of the individual with the remote meeting. In an embodiment, the context data may be obtained from one or more sources and the involvement level may be determined using one or more of the following methodologies.

In an embodiment, determining the involvement level may involve identifying a length of time since the attendee has provided input to the meeting. In this regard, an embodiment may obtain context data that identifies: how long an individual has had a mute control activated on their device, how long has it been since an individual has provided text input to a chat box in the meeting application, how long has it been since a cursor of the individual's device has interacted with an aspect of the media application, and the like. In an embodiment, the identified time period of interaction may be compared to one or more stored indicators (e.g., stored in an accessible database resident locally on the device or resident remotely on another device or server, etc.) of levels of meeting involvement. For example, if an embodiment has identified that an attendee has had a mute control active on their device for substantially the entire meeting, an embodiment may conclude that the attendee is not explicitly engaged in the meeting. In another example, an embodiment may predict that an attendee is involved in the meeting if an embodiment identifies that a user routinely provides voice or text input to the meeting (e.g., every few minutes, in each meeting section, etc.) or interacts with aspects of the meeting application that are indicative of increased meeting interest (e.g., an embodiment identifies that an attendee has increased the volume on their device during a meeting presentation, etc.).

In an embodiment, determining the involvement level may involve identifying a role of the attendee in the meeting. In this regard, an embodiment may obtain context data that identifies whether the attendee was a scheduled presenter in the meeting or is only substantially slated to be a passive participant. For example, an embodiment may identify that the attendee is a meeting organizer or administrator and may predict, from this moderating role, that the attendee will likely be speaking at particular points in the meeting (e.g., at the beginning of the meeting to give introductions, in the middle of the meeting to introduce new speakers, at the end of the meeting to thank the attendees, etc.). Additionally or alternatively, in another example, an embodiment may identify that a meeting is segmented into two or more distinct sections and may determine (e.g., by access to a meeting agenda and/or to an attendee's calendar data, etc.) that the attendee may be scheduled to be speak in one section but not the others. In such a situation, an embodiment may predict that the attendee will be engaged in the meeting at least for those sections during which they are slated to speak.

In an embodiment, determining the involvement level may involve identifying a meeting size associated with the meeting. In this regard, an embodiment may obtain context data that identifies the number of individuals invited to participate in the meeting and/or an embodiment may calculate the actual attendees present in the meeting (e.g., after a meeting has started, etc.). In an embodiment, an attendee's involvement level in the meeting may be inversely proportional to the meeting size. Stated differently, the larger the meeting is, the less likely an attendee may be engaged in the meeting and the more likely they may be amenable to receiving and responding to incoming communications. Conversely, smaller meetings promote a more intimate setting in which an attendee may be more likely to participate and may therefore not be as amenable to receiving and responding to incoming communications.

In an embodiment, determining the involvement level may involve identifying an attendee's responsiveness to one or more previously received communications during the remote meeting. More particularly, an embodiment may identify whether an attendee has opened/responded to one or more communications that they received while they were present in the meeting. In this regard, an attendee's involvement level may be inversely proportional to their responsiveness to received communications. For example, an embodiment may identify that an attendee's is not very involved in a meeting responsive to identifying that an attendee has opened or responded to each previously received communication. In a converse example, an embodiment may identify that an attendee is very involved in a meeting responsive to identifying that the attendee has not opened any incoming communications during the remote meeting.

In an embodiment, determining the involvement level of an attendee in a current meeting, which may be a recurring meeting, may involve identifying how historically engaged the attendee was in previous iterations of the meeting. For example, an embodiment may identify: whether the attendee frequently provided input in past iterations of the meeting, whether the attendee responded to received communications in past iterations of the meeting, whether the attendee went through long periods of having a mute control active, etc. If an embodiment determines that the attendee was very involved in past iterations of the meeting, then an embodiment may conclude that the attendee will be similarly involved in the current meeting, and vice versa.

In an embodiment, determining the involvement level may involve identifying a nature of the remote meeting. More particularly, an embodiment may identify whether the meeting is a social meeting (e.g., in which an individual communicates with other friends and/or family, etc.) or a business meeting (e.g., a meeting that an individual may take part as part of their job, etc.). Such identification may be facilitated by accessing context data that gives an indication of the nature of the meeting (e.g., a time that the meeting occurs, identities of participants in the meeting, etc.). Responsive to this identification, an embodiment may conclude that an attendee is more amendable to accept and respond to incoming communications during a social meeting than a business meeting.

Responsive to not being able to determine, at 302, an involvement level of the individual in the remote meeting, an embodiment may, at 303, take no additional action. Conversely, responsive to determining, at 302, an involvement level of the individual in the remote meeting, an embodiment may, at 304, identify an availability potential of the individual. In an embodiment, the availability potential may refer to a meeting attendee's likelihood of accepting and/or responding to a received communication at a particular point in the meeting. In an embodiment, the availability potential may be inversely proportional to the involvement level. Stated differently, the more involved an attendee is in the meeting at a particular point, the less likely they will be to accept and/or respond to received communications at that time.

At 305, an embodiment may provide an indication of the availability potential of the meeting attendee to at least one other individual. In an embodiment, this provision may be facilitated by an update to a profile status associated with the meeting attendee. This update may convey the availability potential of the meeting attendee via an informative phrase (e.g., “In a meeting but able to receive messages”, “Currently moderating a meeting and cannot respond to messages”, etc.). This profile status may be visible to other individuals attempting to contact the meeting attendee. Alternatively to the foregoing, the indication of the meeting attendee's availability potential may be dynamically transmitted to an individual attempting to communicate with the meeting attendee (e.g., a contacting individual may receive an automatic message containing the indication of the availability potential in response to sending a message to the meeting attendee, etc.).

In an embodiment, when a communication is received by the meeting attendee from another individual, a notification may be provided to the attendee. In an embodiment, this notification may provide an indication of the identity of the contacting individual. Additionally or alternatively, an embodiment may confirm with the attendee that subsequent communications received from the contacting individual during the meeting may be transmitted to the attendee.

The various embodiments described herein thus represent a technical improvement to conventional methods for identifying whether an individual involved in a remote meeting is amenable to accepting communications from others. Using the techniques described herein, an embodiment may obtain context data associated with an attendee involved in a remote meeting. An embodiment may then determine, based on the context data, an involvement level of the individual in the meeting and thereafter identify an availability potential of the attendee based on the involvement level. This identified availability potential may then be communicated to another individual interested in contacting the meeting attendee during the remote meeting. Such a method may preemptively inform other individuals about a meeting attendees' desire to accept and/or respond to a communication.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
obtaining, at an information handling device and from one or more sources, context data associated with an individual participating in a remote meeting, wherein the obtaining the context data comprises identifying a meeting size of the remote meeting and wherein the involvement level is inversely proportional to the meeting size;
determining, based on the context data, an involvement level of the individual in the remote meeting;
identifying, based on the determining, an availability potential of the individual, wherein the availability potential is inversely proportional to the involvement level, wherein the identifying is at least based upon a responsiveness of the individual to a received communication unrelated to the remote meeting, wherein the involvement level is dynamically adjusted during the remote meeting based upon active engagement of the individual and the meeting size; and
providing, based on the identifying, an indication of the availability potential to at least one other individual at a point in time of the received communication.

2. The method of claim 1, wherein the obtaining the context data comprises identifying a mute length of a microphone associated with the information handling device and wherein the involvement level is inversely proportional to the mute length.

3. The method of claim 1, wherein the obtaining the context data comprises identifying an interaction level with a conferencing application that supports the remote meeting and wherein the involvement level is directly proportional to the interaction level.

4. (canceled)

5. The method of claim 1, wherein the obtaining the context data comprises identifying a responsiveness of the individual to one or more received communications during the remote meeting and wherein the involvement level is inversely proportional to the responsiveness of the individual to the one or more other received communications.

6. The method of claim 5, wherein the remote meeting is a recurring meeting and wherein the identifying the responsiveness of the individual comprises accessing historical behavior data associated the responsiveness of the individual to the one or more received communications during past sessions of the remote meeting.

7. The method of claim 1, wherein the obtaining the context data comprises identifying whether the individual is a moderator of the remote meeting and wherein the determining comprises determining that the involvement level is higher responsive to identifying that the individual is the moderator.

8. The method of claim 1, wherein the obtaining the context data comprises identifying whether the remote meeting is a business meeting or a social meeting and wherein the determining comprises determining that the involvement level is higher for the business meeting and lower for the social meeting.

9. The method of claim 1, wherein the providing the indication of the availability potential comprises updating a profile status associated with the individual, wherein the profile status is viewable by the at least one other individual.

10. The method of claim 1, further comprising:
receiving, at the information handling device, an incoming communication from another individual; and
providing, responsive to the receiving, a prompt to the individual, wherein the prompt:
informs the individual about an identity of the another individual; and
requests, from the individual, an affirmation that subsequent communications are receivable from the another individual during the remote meeting.

11. An information handling device, comprising:
a processor;
a memory device that stores instructions executable by the processor to:
obtain, from one or more sources, context data associated with an individual participating in a remote meeting, wherein the obtaining the context data comprises identifying a meeting size of the remote meeting and wherein the involvement level is inversely proportional to the meeting size;
determine, based on the context data, an involvement level of the individual in the remote meeting;
identify, based on the determining, an availability potential of the individual, wherein the availability potential is inversely proportional to the involvement level, wherein the identifying is at least based upon a responsiveness of the individual to a received communication unrelated to the remote meeting, wherein the involvement level is dynamically adjusted during the remote meeting based upon active engagement of the individual and the meeting size; and
provide, based on the identifying, an indication of the availability potential to at least one other individual at a point in time of the received communication.

12. The information handling device of claim 11, wherein the instructions executable by the processor to obtain the context data comprise instructions executable by the processor to identify a mute length of a microphone associated with the information handling device and wherein the involvement level is inversely proportional to the mute length.

13. The information handling device of claim 11, wherein the instructions executable by the processor to obtain the context data comprise instructions executable by the processor to identify an interaction level with a conferencing application that supports the remote meeting and wherein the involvement level is directly proportional to the interaction level.

14. (canceled)

15. The information handling device of claim 11, wherein the instructions executable by the processor to obtain the context data comprise instructions executable by the processor to identify a responsiveness of the individual to one or more received communications during the remote meeting and wherein the involvement level is inversely proportional to the responsiveness of the individual to the one or more other received communications.

16. The information handling device of claim 15, wherein the remote meeting is a recurring meeting and wherein the instructions executable by the processor to identify the responsiveness of the individual comprise instructions executable by the processor to access historical behavior data associated the responsiveness of the individual to the one or more received communications during past sessions of the remote meeting.

17. The information handling device of claim 11, wherein the instructions executable by the processor to obtain the context data comprise instructions executable by the processor to identify whether the individual is a moderator of the remote meeting and wherein the instructions executable by the processor to determine comprise instructions executable by the processor to determine that the involvement level is higher responsive to identifying that the individual is the moderator.

18. The information handling device of claim 11, wherein the instructions executable by the processor to obtain the context data comprise instructions executable by the processor to identify whether the remote meeting is a business meeting or a social meeting and wherein the instructions executable by the processor to determine comprise instructions executable by the processor to determine that the involvement level is higher for the business meeting and lower for the social meeting.

19. The information handling device of claim 11, wherein the instructions are further executable by the processor to:
receive, at the information handling device, an incoming communication from another individual; and
provide, responsive to the receiving, a prompt to the individual, wherein the prompt:
informs the individual about an identity of the another individual; and
requests, from the individual, an affirmation that subsequent communications are receivable from the another individual during the remote meeting.

20. A product, comprising:
a computer-readable storage device that stores executable code that, when executed by a processor, causes the product to:
obtain, from one or more sources, context data associated with an individual participating in a remote meeting, wherein the obtaining the context data comprises identifying a meeting size of the remote meeting and wherein the involvement level is inversely proportional to the meeting size;
determine, based on the context data, an involvement level of the individual in the remote meeting;
identify, based on the determining, an availability potential of the individual, wherein the availability potential is inversely proportional to the involvement level, wherein the identifying is at least based upon a responsiveness of the individual to a received communication unrelated to the remote meeting, wherein the involvement level is dynamically adjusted during the remote meeting based upon active engagement of the individual and the meeting size; and
provide, based on the identifying, an indication of the availability potential to at least one other individual at a point in time of the received communication.
